(19) United States
(12) Patent Application Publication
(10) Pub. No.: US 2010/0132044 A1
(43) Pub. Date: May 27, 2010

(54) Computer Method and Apparatus Providing Brokered Privacy of User Data During Searches

(75) Inventors: Sandra L. Kogan, Newton, MA (US); Michael Muller, Medford, MA (US)

Correspondence Address: HAMILTON, BROOK, SMITH & REYNOLDS, 530 VIRGINIA ROAD, PO BOX 9133, CONCORD, MA, 01742-9133, US

(73) Assignee: INTERNATIONAL BUSINESS MACHINES CORPORATION, Armonk, NY (US)

(21) Appl. No.: 12/277,588

(22) Filed: Nov. 25, 2008

(51) Int. Cl. G06F 21/00

(52) U.S. Cl. 726/26

(57) ABSTRACT

Computer method and apparatus brokers and provides user data in a computer network of users. The invention system stores user data of the users. A search engine enables a searching user to query the stored user data and maintain anonymity of the users. The invention system brokers the query/search results. Each user whose stored user data matches the query maintains stewardship or control over the exposure of her/his user data. An output unit displays to the searching user the matching user data as brokered through (approved and optionally edited by) the respective user.

### BACKGROUND

In certain countries, any data associated with an individual employee is considered private by default, and requires the employee's permission to be shared with other employees. Systems that do not comply with these policy requirements may not be legal for workplace applications in these countries. This is an important issue for social software applications, including those by IBM (e.g., Lotus Connections—assignee) as well as applications implementing some aspects of Open Documents Format standard (e.g., in Lotus Symphony), whether the applications are deployed internally or externally.

There might also be some cultural implications around this issue as well that could hinder or prevent use of these tools, hence collaboration. If people expect privacy by default but realize that these social software applications behave differently than expected, the social software applications might not be used or may be avoided altogether and be considered high risk.

This legal requirement makes it difficult to share metadata that describe an employee, such as the person-tags that have been used by over 500 employees in the Bluepages+1 research prototype. More broadly, this legal requirement makes it difficult to provide employee-searchable records of other employees' expertise for the necessary and frequent tasks of expertise location and expertise management. The problem is that the tags or other attributions of expertise may be considered private to the employee, and therefore not viewable/searchable by other employees without the explicit permission of the person whose data are to be viewed or searched.

Possible legal frameworks that might involve privacy issues of this kind include:
EU Data Protection Directive of 1995
HIPAA
EU Telecommunications Privacy Directive of 1997 and 2002
Canadian Model Code (CMC) for the Protection of Personal Information of 1996

The outcome of a social software application is indirect collaboration so a user's data or records can be shared with someone else without that user having to give explicit permission. While social software applications have become increasingly popular on the public Internet, they are of particular importance to businesses, where they support the interdependent contributions and awareness of members of organizations, teams and task forces.

### BRIEF SUMMARY

The present invention solves the foregoing problems and disadvantages in prior art. In embodiments of the present invention, a search is initiated by a searching user against the private records of one or more anonymous users. If there is a match with any of those private records, the private data of an anonymous user are not exposed to the searching user until the anonymous user has given permission. Each anonymous user maintains stewardship (control) over the exposure of her/his personal data. This kernel idea of the present invention has a number of optional steps, including the use of anonymous proxies to serve as intermediary representations between the searching user and one or more anonymous users.

In one embodiment, a computer method of providing user data comprises:

(a) in a computer network of users, storing user data of the users;

(b) for a given user, enabling the given user to query the stored user data in a manner maintaining anonymity of each user to which the stored user data is with respect to;

(c) brokering (e.g., centrally brokering) query results by:

(i) notifying each anonymous user whose stored user data matches the given user query, and

(ii) for each notified anonymous user, effectively obtaining permission from the anonymous user to expose her/his user data to the given user; and

(d) providing as output to the given user, indications of the user data from each anonymous user that gave her/his permission to expose her/his user data to the given user.

According to some embodiments, the stored user data includes any of sensitive user data, private user data and personal user data.

In one embodiment, identity of the given user is maintained reciprocally anonymous to the anonymous users. In other embodiments, identity of the given user is revealed to one or more of the anonymous users. The given user may determine whether her/his identity is exposed to each (one or more) of the anonymous users.

In one embodiment, the step of effectively obtaining permission from the anonymous user includes offering the anonymous user to respond with her/his user data. The offering to the anonymous user to respond may be conducted automatically based on prior established (predefined) preferences of the anonymous user. Alternatively, the step of offering the anonymous user to respond is conducted in accordance with a policy or is rules generated or the like.

In some embodiments, the step of notifying each anonymous user includes employing any one or a combination/plurality of communications media. The plurality of communications media may include instant messaging, text-to-speech messaging, telephone messaging and mobile phone messaging and other messaging/communications types.

In other embodiments, the step of obtaining permission from the anonymous user obtains permission to expose her/his user data in a manner specified by the anonymous user. The system then outputs to the given user, a display of the user data of the anonymous user as edited by the anonymous user. In editing the user data, the anonymous user may withhold personally identifying data but allow crucial data values of her/his user data to be displayed to the given user. The crucial data values may include any of: name of city of residence instead of address of the anonymous user, age category instead of a specific age of the anonymous user; and age/year range instead of birth date of the anonymous user. In one embodiment, the given user specifies data ranges for crucial data values and the anonymous user chooses which of her/his data fits into each of the data ranges.

In another embodiment, a computer system or apparatus providing user data implements the foregoing method. Briefly, one embodiment involves the storage of the sensitive data in either a centralized, highly secure database (or datastore), or in a distributed series of private user profiles. This is in contrast to prior art processes that involve user control of private data, through the storage of private data within the user's own computer.

The definition of “privacy” in this disclosure is intended to follow a fairly broad model. Any data that is about an employee (whether provided by that employee or by others) may be considered private to that employee—whether or not the employee would rate it as private, and whether or not the data were provided in a public or private process. Note that “private” in this interpretation may include the sense of “private from other employees,” not just “private with regard to outsiders.” Thus, the restrictions addressed by the present invention are not the conventional US restrictions, but are a much tighter set of constraints.

### BRIEF DESCRIPTION OF THE SEVERAL VIEWS OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic view of a computer network in which embodiments of the present invention are implemented.

FIG. 2 is a block diagram of computer nodes in the network of FIG. 1.

FIG. 3 is a flow diagram of an embodiment of the present invention.

### DETAILED DESCRIPTION

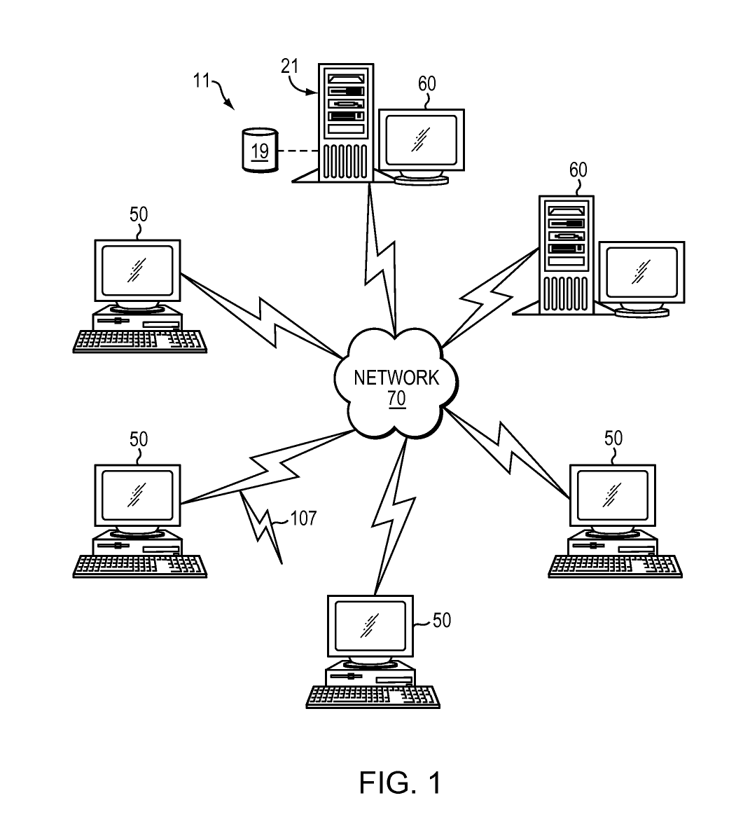

With reference now to FIG. 1, embodiments 11 of the present invention store sensitive data of each user, in a network of computers 50, 60, in either a centralized, highly secure database 19 (of for example server 60) or in a distributed series of private user profiles at server 60. The central database 19 may be a relational or other suitable type of database or a data store using common techniques/technology. The user profiles may be implemented by programming objects, other files/records structures and the like. It is understood that other (e.g., non-central, distributed and the like) database and data store configurations are suitable. The subject data may be stored on a user community-basis leading to multiple servers 60. For ease of discussion, the database/data store and user profiles are generally referenced 19 and are preferably effectively centralized with respect to invention system 11. As will be made clearer below, invention system 11 enables each user to maintain stewardship over the exposure of her/his respective personal (sensitive) data and records (generally referenced 19).

FIG. 1 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

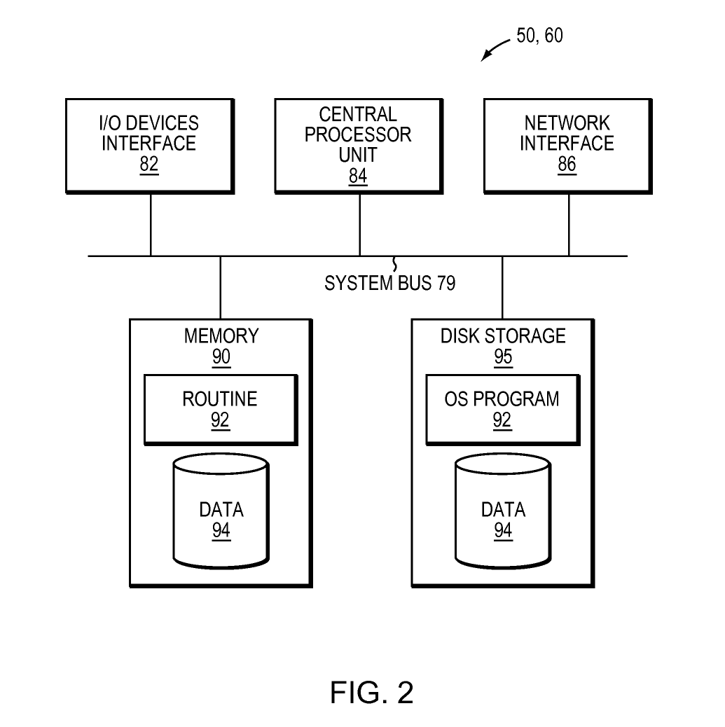

FIG. 2 is a diagram of the internal structure of a computer (e.g., client processor/device 50 or server computers 60) in the computer system of FIG. 1. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 1). Memory 90 provides volatile storage for computer software instructions 92 and data 94 used to implement an embodiment of the present invention (e.g., search engine 21, search results broker/brokering member 35 and other support code detailed below). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

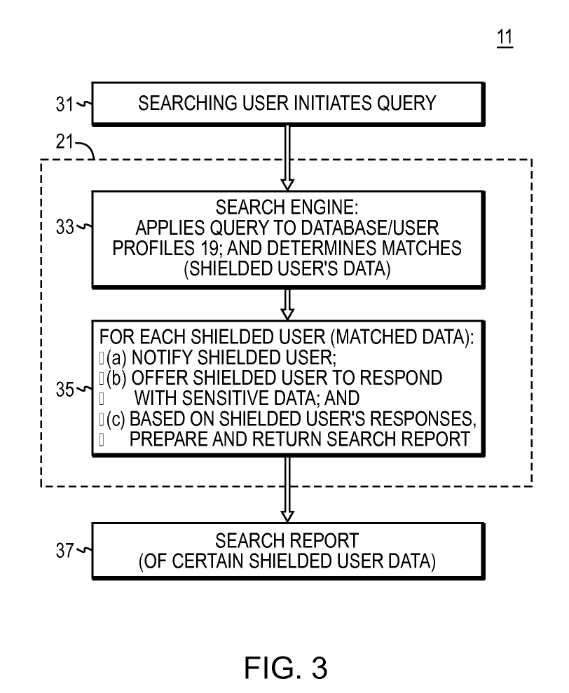

Referring now to FIG. 3, the basic process of the invention system 11 is as follows. At step 31, the searching user initiates a query, via a search engine 21, that may involve private data associated with other users (shielded users). The private data 19 is stored as previously described with reference to FIG. 1.

In response (step 33), the search engine 21 processes the query against the centralized (or network distributed, or other) database or series of private user profiles (generally 19) described above. The search engine 21 determines that there exists one or more matches for the query among the data 19 of one or more of the shielded users.

For each shielded user whose data 19 are matched, the search engine 21 conducts the following steps 35:

(a) Notifies the shielded user of the query and the possibility of a match. In one embodiment, the invention system 11 establishes reciprocal anonymity between the searching user and each shielded user. In another embodiment, the invention system 11 reveals the identity of the searching user to each shielded user. In one approach, the searching user determines whether her/his identity is exposed to each shielded user. This determination may be made during the query process by user selectable command, user-definable rule, or the like. In another approach, a system 11 policy or Rule or the like determines whether her/his identity is exposed to each shielded user.

(b) Offers the shielded user the opportunity to respond to the search with her/his data. In one embodiment, this step may be conducted automatically, based on stored preferences of each respective shielded user. In another embodiment, this step may be conducted in accordance with organizational policies (e.g. implemented by Rules). In yet another embodiment, if the searching user indicated that the query was time-critical, then the system 11 might use a plurality of communications media to contact each matched shielded user, possibly including IM (Instant Messaging), a text-to-speech messaging and/or Dual Tone Multi-frequency (DTMF)-to-response dialogue via telephone (mobile phone, etc.).

(c) Responsive to the answers of each shielded user, assembles a search report—In one embodiment, the invention system 11 provides all relevant personal data 19 from each consenting shielded user that are requested by the searching user. In another embodiment, the system 11 allows a consenting shielded user to edit the personal data 19 before the data is returned to the searching user. In another embodiment, the invention system 11 allows each shielded user the option of providing crucial data values while withholding personally-identifying data (e.g., city of residence but not address, or employee age category but not employee specific age or birthdate, etc.). In other embodiments, the searching user specifies data ranges for crucial data values and the shielded user chooses which of her/his data fits into each of the data ranges. Known technology or techniques may be used to implement these alternatives and options.

(d) Returns the search report 37 to the searching user.

Thus, the present invention systems and method 11 allow searching on user data 19 in an anonymous way. A proxy for a user's identity is not key to invention system 11 and is not necessarily provided. Instead, invention system 11 (i) determines that there is a match to the search query and then (ii) effectively asks the owner (shielded user) of the data 19 for permission to share the matched information with the searcher (searching user). Some embodiments allow the system 11 to shield or otherwise hide from view the user's (shielded user's) identity from the searcher (searching user) and vice versa, but this feature is not core to the present invention. The core concept of the present invention is to support an anonymous search (e.g., step 33, FIG. 3) for relevant user attributes and then to broker (e.g., step 35) the delivery of the search results 37 to the searcher (searching user).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer method of providing user data, comprising:
in a computer network of users, storing user data of the users;
for a given user, enabling the given user to query the stored user data in a manner maintaining anonymity of each user to which the stored user data is with respect to;
brokering query results by:
(i) notifying each anonymous user whose stored user data matches the given user query, and
(ii) for each notified anonymous user, effectively obtaining permission from the anonymous user to expose his user data to the given user; and
providing as output to the given user, indications of the user data from each anonymous user that gave his permission to expose his user data to the given user.

2. The computer method as claimed in claim 1 wherein the stored user data includes any of sensitive user data, private user data and personal user data.

3. The computer method as claimed in claim 1 wherein identity of the given user is maintained reciprocally anonymous to the anonymous users.

4. The computer method as claimed in claim 1 where identity of the given user is revealed to the anonymous users.

5. The computer method as claimed in claim 4 wherein the given user determines whether his identity is exposed to each anonymous user.

6. The computer method as claimed in claim 1 wherein the step of effectively obtaining permission from the anonymous user includes offering the anonymous user to respond with his user data.

7. The computer method as claimed in claim 6 wherein the step of offering the anonymous user to respond is conducted automatically based on preferences of each respective anonymous user.

8. The computer method as claimed in claim 6 wherein the step of offering the anonymous user to respond is conducted in accordance with a policy.

9. The computer method as claimed in claim 1 wherein the step of notifying each anonymous user includes employing a plurality of communications media.

10. The computer method as claimed in claim 9, wherein the plurality of communications media includes instant messaging, text-to-speech messaging, telephone messaging and mobile phone messaging.

11. The computer method as claimed in claim 1 wherein the step of obtaining permission from the anonymous user obtains permission to expose his user data in a manner specified by the anonymous user; and
the step of providing outputs to the given user the user data of the anonymous user as edited by the anonymous user.

12. The computer method as claimed in claim 11 wherein the anonymous user withholds personally identifying data but allows crucial data values of his user data to be displayed to the given user.

13. The computer method as claimed in claim 12 wherein the crucial data values include any of: name of city of residence instead of address of the anonymous user, age category instead of a specific age of the anonymous user; and age range instead of birth date of the anonymous user.

14. The computer method as claimed in claim 12 wherein the given user specifies data ranges for crucial data values, and the anonymous user chooses which of his data fits into one or more of the data ranges.

15. Computer apparatus providing user data comprising:
in a network of computer users, a data store storing user data of the users;
a search engine coupleable to the data store and configured to enable a given user to query the stored user data in a manner maintaining anonymity of the users;
a brokering member brokering results of queries processed by the search engine, the brokering member enabling each user whose stored user data matches the given user query, to maintain stewardship over exposure of his respective user data; and
an output unit responsive to the brokering member and displaying to the given user respective user data from each anonymous user (i) whose stored user data matches the given user query and (ii) who gives permission to display his user data as brokered by the brokering member.

16. The computer apparatus as claimed in claim 15 wherein the stored user data includes any of sensitive user data, private user data and personal user data.

17. The computer apparatus as claimed in claim 15 wherein identity of the given user is any one or combination of:
maintained reciprocally anonymous to users in the network;
revealed to one or more users in the network; and
exposed to each of the one or more users as determined by the given user.

18. The computer apparatus as claimed in claim 15 wherein the brokering member:
(i) notifies each anonymous user whose stored user data matches the given user query; and
(ii) for each notified anonymous user, effectively obtains permission from the anonymous user including optionally offering the anonymous user to respond with his user data.

19. The computer apparatus as claimed in claim 18 wherein the brokering member offering the anonymous user to respond employs any of a policy and preferences of each respective anonymous user.

20. The computer apparatus as claimed in claim 15 wherein the brokering member notifies each anonymous user whose stored user data matches the given user query, said notifying, employing any one or combination of communications media.

21. The computer apparatus as claimed in claim 20 wherein the communications media includes instant messaging, text-to-speech messaging, telephone messaging and mobile phone messaging.

22. The computer apparatus as claimed in claim 15 wherein the brokering member obtains permission from the anonymous user to expose his user data in a manner specified by the anonymous user; and
the output unit displays to the given user the user data of the anonymous user as edited by the anonymous user.

23. The computer apparatus as claimed in claim 22 wherein the user data is edited by the anonymous user includes crucial data values with personally identifying data withheld, the crucial data values including any of: name of city of residence instead of address of the anonymous user, age category instead of specific age of the anonymous user; and year range instead of birth date of the anonymous user.

24. The computer apparatus as claimed in claim 23 wherein the given user specifies data ranges for crucial data values, and the anonymous user chooses which of his data fits into each of the data ranges.

25. A computer program product for providing user data, the computer program product comprising:
a computer usable medium having computer usable program code embodied therewith, the computer usable program code comprising:
computer usable program code configured to store user data of users in a computer network;
computer usable program code configured to, for a given user, enable the given user to query the stored user data in a manner maintaining anonymity of the users;
computer usable program code configured to broker query results in a manner that enables each user, whose stored user data matches the given user query, to maintain stewardship over exposure of his respective user data; and
computer usable program code configured to display to the given user brokered, respective user data from each anonymous user whose stored user data matches the given user query and gives permission to display his user data.
